(19) United States
(12) Patent Application Publication
(10) Pub. No.: US 2026/0261290 A1
(43) Pub. Date: Sep. 3, 2026

(54) METHOD AND APPARATUS FOR MONITORING ORIENTATION OF SIGNAL SOURCE, STORAGE MEDIUM, AND SMART DEVICE

(71) Applicant: SHENZHEN TCL DIGITAL TECHNOLOGY LTD, Shenzhen (CN)

(72) Inventors: Liuzhong YIN, Shenzhen (CN); Zitonh Wang, Shenzhen (CN); Kangqing GUO, Shenzhen (CN); Shengpeng SUN, Shenzhen (CN)

(73) Assignee: SHENZHEN TCL DIGITAL TECHNOLOGY LTD, Shenzhen (CN)

(21) Appl. No.: 18/995,775

(22) PCT Filed: May 15, 2023
(86) PCT No.: PCT/CN2023/094145

§ 371 Date: Jan. 16, 2025

(30) Foreign Application Priority Data
Aug. 16, 2022 (CN) 202210986071.8

(51) Int. Cl. H04B 7/0408; H04B 17/20; H04B 17/318

(52) U.S. Cl. CPC H04B 7/0408; H04B 17/252; H04B 17/318

(57) ABSTRACT

A method and an apparatus for monitoring an azimuth of a signal source, a storage medium, and a smart device are provided. The method includes: controlling phases and excitation amplitudes of four antennas in a smart terminal to generate a plurality of beam groups, each beam group including a sum beam and a difference beam; mapping beam patterns corresponding to the beam group in a preset beam coordinate system; setting an azimuth angle and an azimuth ray, and acquiring a signal strength difference of the sum beam and the difference beam in each beam group on the azimuth ray; analyzing a variation law between the signal strength difference and the azimuth angle, and performing a direction verification on a direction of the signal source based on a comparison of signal strengths of the sum beam and the difference beam of the beam groups.

### TECHNICAL FIELD

This application claims priority to Chinese Patent Applications No. 202210986071.8, filed on Aug. 16, 2022 and entitled “METHOD AND APPARATUS FOR MONITORING ORIENTATION OF SIGNAL SOURCE, STORAGE MEDIUM, AND SMART DEVICE”. The entire disclosures of the above application are incorporated herein by reference.

The present application relates to the field of signal processing technology, and in particular to a method and an apparatus for monitoring an azimuth of a signal source, a storage medium, and a smart device.

### BACKGROUND TECHNOLOGY

With improvement of people's living standards and development of electronic technology, smart devices such as smart TVs, home audio and video systems, smart refrigerators, etc. are becoming more and more popular in people's lives. These smart devices have wireless network communication functions, and their wireless network communication is transmitted through router devices.

However, since a location of a router antenna relative to the smart device in the home is not fixed, in order to ensure that the smart device and the router can communicate well at any location around the smart device, the antenna in the smart device must have an ability to communicate horizontally in an omnidirectional manner.

At present, in order to enable an antenna of a smart device to have qn ability of horizontal omnidirectional communication, a multi-antenna array is usually used, and the antenna needs to be mechanically rotated through mechanical structure design. This setting method is relatively complicated and increases space occupied by the antenna setting of the smart device.

### Technical Problem

Embodiments of the present application provide a method and an apparatus for monitoring an azimuth of a signal source, a storage medium, and a smart device, which are configured to solve problems raised in the above background technology.

### SUMMARY OF INVENTION

In a first aspect, an embodiment of the present application provides a method for monitoring an azimuth of a signal source, which is applied to a smart device, and the method includes:
controlling phases and excitation amplitudes of four antennas in the smart terminal respectively through a radio frequency switch and a phase-shift power division network to generate a plurality of beam groups, where each of the beam groups includes a sum beam and a difference beam, and the four antennas include a first antenna, a second antenna, a third antenna, and a fourth antenna arranged in four directions.
mapping beam patterns corresponding to the sum beam and the difference beam in each of the beam groups in a preset beam coordinate system.
setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray.
analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

In some embodiments, the setting the at least one azimuth angle, setting the corresponding azimuth ray from the coordinate origin of the beam coordinate system based on the azimuth angle, and acquiring the signal strength difference of the sum beam and the difference beam in each of the beam groups on the azimuth ray, includes:
acquiring a first signal strength of the sum beam and a second signal strength of the difference beam of each of the beam groups on the azimuth ray.
solving a difference between the first signal strength and the second signal strength as the signal strength difference of the beam group.

In some embodiments, the acquiring the first signal strength of the sum beam and the second signal strength of the difference beam of each of the beam groups on the azimuth ray includes:
if the sum beam of the beam group on the azimuth ray includes a plurality of signal strength values, comparing the plurality of signal strength values numerically, and determining a signal strength value on a main lobe of the sum beam as the first signal strength.

In some embodiments, after determining the signal strength value on the main lobe of the sum beam as the first signal strength, the method further includes:
based on a coordinate axis and the coordinate origin of the beam coordinate system, dividing the beam coordinate system into four coordinate areas in 360° direction.
determining a signal strength value of the difference beam of an antenna mode in a same position area as the first signal strength as the second signal strength.

In some embodiments, the controlling the phases and the excitation amplitudes of the four antennas in the smart terminal respectively through the radio frequency switch and the phase-shift power division network to generate the plurality of beam groups, each of the beam groups including the sum beam and the difference beam, and the four antennas including the first antenna, the second antenna, the third antenna, and the fourth antenna arranged in four directions includes:
controlling the first antenna and the second antenna to have a same phase and a same amplitude, and controlling the third antenna and the fourth antenna to have a same phase and a same amplitude, and simultaneously controlling the first antenna and the second antenna to be in a first phase, and obtaining a sum beam radiated in a preset direction.

In some embodiments, the controlling the phases and the excitation amplitudes of the four antennas in the smart terminal respectively through the radio frequency switch and the phase-shift power division network to generate the plurality of beam groups, each of the beam groups including the sum beam and the difference beam, and the four antennas including the first antenna, the second antenna, the third antenna, and the fourth antenna arranged in four directions includes:
controlling the excitation amplitudes of the first antenna and the fourth antenna to be the same, and controlling the second antenna and the third antenna not to be excited, and obtaining a difference beam radiated in a preset direction by adjusting a phase difference between the first antenna and the fourth antenna.

In some embodiments, the four antennas are all configured as vertically polarized antennas.

In a second aspect, an embodiment of the present application provides an apparatus for monitoring an azimuth of a signal source, which is applied to a smart device, and the apparatus includes:
a control unit configured to control phases and excitation amplitudes of four antennas in the smart terminal respectively through a radio frequency switch and a phase-shift power division network to generate a plurality of beam groups, where each of the beam groups includes a sum beam and a difference beam, and the four antennas include a first antenna, a second antenna, a third antenna, and a fourth antenna arranged in four directions.
a mapping unit configured to map beam patterns corresponding to the sum beam and the difference beam in each of the beam groups in a preset beam coordinate system.
an acquisition unit configured to set at least one azimuth angle, set a corresponding azimuth ray from a coordinate origin of the beam coordinate system based on the azimuth angle, and acquire a signal strength difference of the sum beam and the difference beam in each of the beam groups on the azimuth ray.
a determination unit configured to analyze a variation law between the signal strength difference and the azimuth angle based on the signal strength difference and the azimuth angle of each of the beam groups, perform a direction verification on a direction of the signal source based on a comparison of signal strengths of the sum beam and the difference beam of the plurality of beam groups, and determine the azimuth point of the signal source based on the variation law and a result of the direction verification.

In a third aspect, an embodiment of the present application provides a storage medium on which a plurality of instructions are stored, where the instructions are suitable for being loaded by a processor to execute the above-mentioned method for monitoring the azimuth of the signal source.

In a fourth aspect, an embodiment of the present application provides a smart device, a signal source is positioned by using any of the above-mentioned method for monitoring the azimuth of the signal source.

In a fifth aspect, an embodiment of the present application provides a method for monitoring an azimuth of a signal source, which is applied to a smart device, and is characterized in that the method includes:
controlling phases and excitation amplitudes of four antennas in the smart terminal respectively through a radio frequency switch and a phase-shift power division network to generate a plurality of beam groups, where each of the beam groups includes a sum beam and a difference beam, the four antennas are all configured as vertically polarized antennas, and the four antennas include a first antenna, a second antenna, a third antenna, and a fourth antenna arranged in four directions.
mapping beam patterns corresponding to the sum beam and the difference beam in each of the beam groups in a preset beam coordinate system.
setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray.
analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

In some embodiments, the phases and the excitation amplitudes of the four antennas are controlled so that working modes of the four antennas exhibit are different, and in each of the working modes, different beam groups are generated relative to the signal source, and each of the beam groups includes the sum beam and the difference beam.

In some embodiments, the setting the at least one azimuth angle, setting the corresponding azimuth ray from the coordinate origin of the beam coordinate system based on the azimuth angle, and acquiring the signal strength difference of the sum beam and the difference beam in each of the beam groups on the azimuth ray, includes:
acquiring a first intersection point of the azimuth ray with the sum beam and a second intersection point of the azimuth ray with the difference beam, serving a signal strength at the first intersection point as a first signal strength of the sum beam, and serving a signal strength at the second intersection point as a second signal strength of the difference beam.
solving a difference between the first signal strength and the second signal strength as the signal strength difference of the beam group.

In some embodiments, the acquiring the first intersection point of the azimuth ray with the sum beam and the second intersection point of the azimuth ray with the difference beam, serving the signal strength at the first intersection point as the first signal strength of the sum beam, and serving the signal strength at the second intersection point as the second signal strength of the difference beam, includes:
if there are a plurality of intersection points between the azimuth ray and the sum beam, comparing values of signal strengths of the intersection points, and serving a determined signal strength with a maximum value of a corresponding intersection point as the first signal strength.

In some embodiments, the first signal strength is a main lobe signal strength value of the sum beam.

In some embodiments, after determining the first signal strength, the method further includes:
when there are a plurality of signal strengths of the difference beam, selecting a signal strength located in a same coordinate area as the first signal strength as the second signal strength.

In some embodiments, the selecting the signal strength located in the same coordinate area as the first signal strength as the second signal strength when there are the plurality of signal strengths of the difference beam, includes:
based on a coordinate axis and the coordinate origin of the beam coordinate system, dividing the beam coordinate system into four coordinate areas in 360° direction.
selecting the signal strength located in the same coordinate area as the first signal strength as the second signal strength.

In a sixth aspect, an embodiment of the present application provides an apparatus for monitoring an azimuth of a signal source, which is applied to a smart device, and the apparatus includes:
a control unit configured to control phases and excitation amplitudes of four antennas in the smart terminal respectively through a radio frequency switch and a phase-shift power division network to generate a plurality of beam groups, where each of the beam groups includes a sum beam and a difference beam, the four antennas are all configured as vertically polarized antennas, and the four antennas include a first antenna, a second antenna, a third antenna, and a fourth antenna arranged in four directions.
a mapping unit configured to map beam patterns corresponding to the sum beam and the difference beam in each of the beam groups in a preset beam coordinate system.
an acquisition unit configured to set at least one azimuth angle, set a corresponding azimuth ray from a coordinate origin of the beam coordinate system based on the azimuth angle, and acquire a signal strength difference of the sum beam and the difference beam in each of the beam groups on the azimuth ray.
a determination unit configured to analyze a variation law between the signal strength difference and the azimuth angle based on the signal strength difference and the azimuth angle of each of the beam groups, perform a direction verification on a direction of the signal source based on a comparison of signal strengths of the sum beam and the difference beam of the plurality of beam groups, and determine the azimuth point of the signal source based on the variation law and a result of the direction verification.

In a seventh aspect, an embodiment of the present application provides a storage medium on which a plurality of instructions are stored, where the instructions are suitable for being loaded by a processor to execute the above-mentioned method for monitoring the azimuth of the signal source.

In an eighth aspect, an embodiment of the present application provides a smart device, a signal source is positioned by using any of the above-mentioned methods for monitoring the azimuth of the signal source.

### Beneficial Effects

The method for monitoring the azimuth of the signal source in the embodiments of the present application is applied to the smart terminal. The smart device can automatically verify the azimuth of the signal source according to the variation law of the signal strength difference of the antenna with the azimuth angle and through multiple beam groups to determine the azimuth of the signal source.

### BRIEF DESCRIPTION OF THE DRAWINGS

In order to more clearly illustrate technical solutions in the embodiments of the present application, accompanying drawings required for use in the description of the embodiments will be briefly introduced below. Apparently, the accompanying drawings described below are only some embodiments of the present application. For those skilled in the art, other accompanying drawings can be obtained based on these drawings without paying any creative efforts.

FIG. 1 is a schematic diagram of a partial structure of a smart terminal provided by an embodiment of the present application.

FIG. 2 is a flowchart of a method for monitoring an azimuth of a signal source provided by an embodiment of the present application.

FIG. 3 is a first example diagram of a method for monitoring an azimuth of a signal source provided by an embodiment of the present application.

FIG. 4 is a second example diagram of a method for monitoring an azimuth of a signal source provided by an embodiment of the present application.

FIG. 5 is a third example diagram of a method for monitoring an azimuth of a signal source provided by an embodiment of the present application.

FIG. 6 is a fourth example diagram of a method for monitoring an azimuth of a signal source provided by an embodiment of the present application.

FIG. 7 is a fifth example diagram of a method for monitoring an azimuth of a signal source provided by an embodiment of the present application.

FIG. 8 is a sixth example diagram of a method for monitoring an azimuth of a signal source provided by an embodiment of the present application.

FIG. 9 is a schematic diagram of a structure of an apparatus for monitoring an azimuth of a signal source provided by an embodiment of the present application.

### DETAILED DESCRIPTION OF THE EMBODIMENTS

The following will be combined with the accompanying drawings in the embodiments of the present application to clearly and completely describe the technical solutions in the embodiments of the present application. Apparently, the described embodiments are only part of the embodiments of the present application, not all of the embodiments. Based on the embodiments in the present application, all other embodiments obtained by those skilled in the art without creative efforts are within the scope of protection of the present application.

The embodiments of the present application provide a method and an apparatus for monitoring an azimuth of a signal source, a storage medium, and a smart device. The smart device can automatically locate the azimuth of the signal source according to a variation law of a signal strength difference of an antenna with an azimuth angle, thereby adjusting a working mode of the antenna for optimal signal reception relative to the signal source to ensure a network transmission performance of the smart device. The method and the apparatus for monitoring the azimuth of the signal source, the storage medium, and the smart device will be described in detail below.

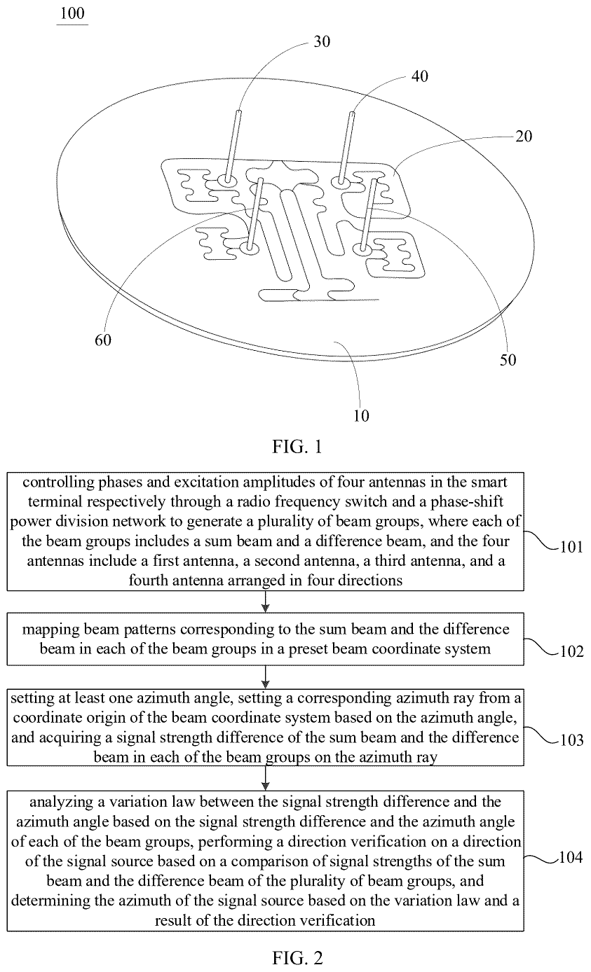

Please refer to FIG. 1, which is a schematic diagram of a partial structure of a smart device provided in an embodiment of the present application. The smart device in the embodiment of the present application includes but is not limited to a smart TV, a smart refrigerator, or a home audio-visual system, etc., which has a network signal receiving function.

The smart device is wirelessly connected to a wireless network device such as a router, and can receive network signals from the wireless network device. A signal unit 100 for realizing signal reception and control functions is provided in the smart device. The signal unit 100 includes a chassis 10, a phase-shift power division network 20, and four antennas arranged in four directions. The four antennas are respectively a first antenna 30, a second antenna 40, a third antenna 50, and a fourth antenna 60.

The four antennas are all configured as vertically polarized antennas. A setting method of the vertically polarized antennas is related to the installation and placement of the smart device and the wireless network device.

The four antennas are all arranged on the chassis 10, and the phase-shift power division network 20 is also arranged on the chassis 10. The four antennas and the phase-shift power division network 20 are grounded through the chassis 10. The four antennas are all electrically connected to the phase-shift power division network 20. Phases and excitation amplitudes of the four antennas are controlled by the phase-shift power division network 20, so as to achieve a purpose of controlling various working modes of the antenna.

In an embodiment of the present application, the chassis 10 is designed to be a disc structure, and each antenna and the phase-shift power division network 20 are carried by the chassis 10, and each antenna and the phase-shift power division network 20 are grounded through the chassis 10.

In other embodiments, the chassis 10 may be configured as a square plate structure or a structure of other shapes, which is not limited herein.

For the four directions arrangement of the four antennas, in this application, the first antenna 30, the second antenna 40, the third antenna 50, and the fourth antenna 60 are arranged in four directions respectively. The four directions can be understood as the four directions of east, west, south, and north. After the four antennas are arranged in the four directions, the four antennas are arranged in a rectangular or square shape.

For example, after the four antennas are arranged in the four directions, the first antenna 30, the second antenna 40, the third antenna 50, and the fourth antenna 60 are all used as vertices. Moreover, the shape formed by connecting the four vertices in sequence is a square.

Furthermore, a radio frequency switch is provided in the phase-shift power division network 20. The phase of each antenna is controlled by the radio frequency switch. Furthermore, the excitation amplitude of each antenna is controlled by the phase-shift power division network 20, so that different working modes are formed between the four antennas. The radio frequency switch can be set as a multi-pole multi-throw switch. The radio frequency switch can control the conduction or disconnection of each antenna.

It is understandable that, in addition to the signal unit 100, the smart device should also be provided with other structures and functional modules, which will not be described in detail here.

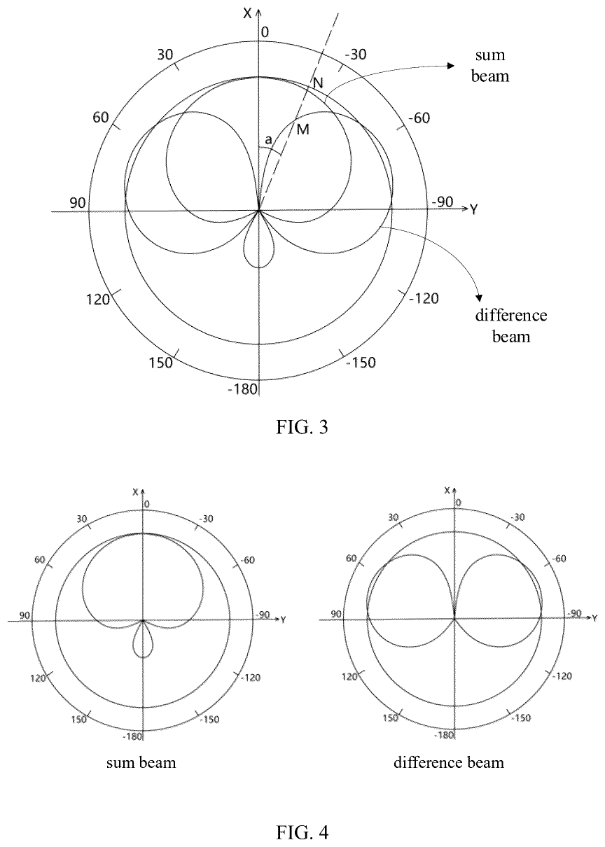

Please refer to FIG. 2 to FIG. 8, FIG. 2 is a flowchart of a method for monitoring an azimuth of a signal source provided by an embodiment of the present application, and FIG. 3 to FIG. 8 are six example diagrams of a method for monitoring an azimuth of a signal source provided by an embodiment of the present application. The method is applied to a smart terminal and includes the following contents:
101, controlling phases and excitation amplitudes of four antennas in the smart terminal respectively through a radio frequency switch and a phase-shift power division network to generate a plurality of beam groups, where each of the beam groups includes a sum beam and a difference beam, and the four antennas include a first antenna, a second antenna, a third antenna, and a fourth antenna arranged in four directions.

The smart terminal is provided with the first antenna, the second antenna, the third antenna, and the fourth antenna arranged in four directions. Also, the four antennas are all vertically polarized antennas. The smart terminal is provided with the radio frequency switch and the phase-shift power division network for controlling the phases and excitation amplitudes of the four antennas. The radio frequency switch can be a circuit component of the phase-shift power division network.

By controlling the phases and excitation amplitudes of the four antennas, the four antennas can present different working modes. In addition, in each working mode, different beam groups are generated relative to the signal source, and each beam group includes a sum beam and a difference beam.

In an embodiment of the present application, the step includes: controlling the first antenna and the second antenna to have a same phase and a same amplitude, and controlling the third antenna and the fourth antenna to have a same phase and a same amplitude, and simultaneously controlling the first antenna and the second antenna to be in a first phase, and obtaining a sum beam radiated in a preset direction.

For example, the phases and the excitation amplitudes of the first antenna and the second antenna are controlled to be the same. Also, the phases and the excitation amplitudes of the third antenna and the fourth antenna are controlled to be the same. At the same time, the phases of the first antenna and the second antenna are controlled to be 90°, and the sum beam shown in FIG. 3 can be obtained. On this basis, a 180° phase is added to the second antenna and the fourth antenna, and the difference beam shown in FIG. 3 can be obtained.

The example diagram of the sum beam in FIG. 4 corresponds to the sum beam in FIG. 3, and the example diagram of the difference beam in FIG. 4 corresponds to the difference beam in FIG. 3.

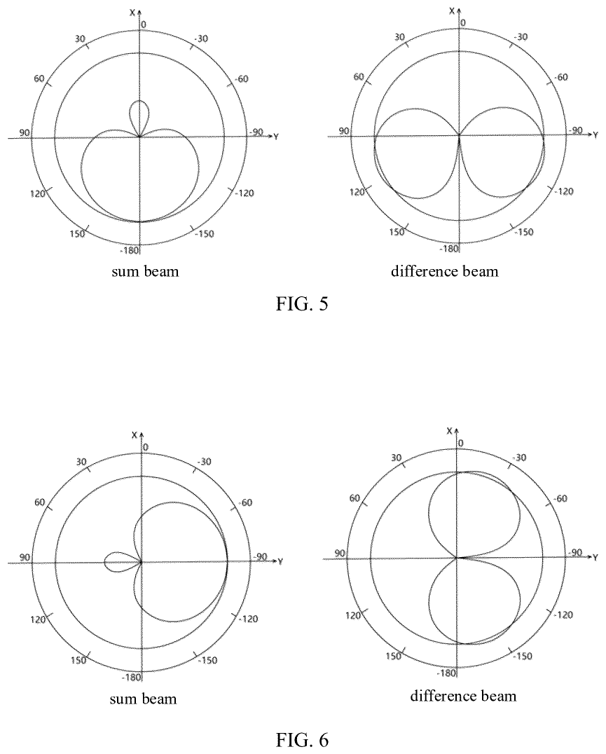

Based on the above examples, through the same control method, the example diagrams of the sum beam and the difference beam as shown in FIG. 5 to FIG. 7 can be obtained.

In an embodiment of the present application, the step also includes: controlling the excitation amplitudes of the first antenna and the fourth antenna to be the same, and controlling the second antenna and the third antenna not to be excited, and obtaining a difference beam radiated in a preset direction by adjusting a phase difference between the first antenna and the fourth antenna.

For example, the excitation amplitudes of the first antenna and the fourth antenna are controlled to be the same. Also, the phase difference between the first antenna and the fourth antenna is 180°. Meanwhile, the second antenna and the third antenna are controlled not to be excited, and a difference beam as shown on a left side of FIG. 8 can be obtained.

For example, the excitation amplitudes of the second antenna and the third antenna are controlled to be the same. Also, the phase difference between the second antenna and the third antenna is 180°. At the same time, the first antenna and the fourth antenna are controlled not to be excited, and a difference beam as shown on a right side of FIG. 8 can be obtained.
102, mapping beam patterns corresponding to the sum beam and the difference beam in each of the beam groups in a preset beam coordinate system.

A coordinate origin in the beam coordinate system can be set to coincide with a source point of the sum beam and the difference beam. A horizontal coordinate and a vertical coordinate in the beam coordinate system can be set corresponding to the arrangement direction of the above four antennas. In addition, the beam coordinate system can be divided into four coordinate areas according to the horizontal coordinate and the vertical coordinate.

In the embodiment of the present application, mapping the beam pattern corresponding to the sum beam and the difference beam in the preset beam coordinate system is actually mapping beam shapes of the sum beam and the difference beam in space in the preset beam coordinate system. The mapping results can be seen in FIG. 3 to FIG. 8.
103, setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray.

Taking FIG. 3 as an example to illustrate this step, it can be understood that the sum beam and the difference beam in FIG. 3 are both mapped in the beam coordinate system. An angle a in the figure is a set azimuth angle. A dotted line in the figure is the azimuth ray made based on the azimuth angle a and the coordinate origin. There are two intersection points between the azimuth ray and the sum beam and the difference beam. The two intersection points are a first intersection point N and a second intersection point M. A signal strength at the first intersection point N is a signal strength on the sum beam located on the azimuth ray. A signal strength at the second intersection point M is a signal strength on the difference beam located on the azimuth ray. Then, the signal strength difference between the sum beam and the difference beam is a difference between the signal strength at the first intersection point N and the signal strength at the second intersection point M.

In an embodiment of the present application, the step includes: acquiring a first signal strength of the sum beam and a second signal strength of the difference beam of each of the beam groups on the azimuth ray; solving a difference between the first signal strength and the second signal strength as the signal strength difference of the beam group.

Taking FIG. 3 as an example, after setting the azimuth angle a and setting the azimuth ray based on the azimuth angle a and the coordinate origin, the azimuth ray has the first intersection point N and the second intersection point M with the sum beam and the difference beam. The first intersection point N is located on the sum beam, and the second intersection point M is located on the difference beam. Then, the signal strength at the first intersection point N is used as the first signal strength of the sum beam, and the signal strength at the second intersection point M is used as the second signal strength of the difference beam.

Alternatively, the acquiring the first signal strength of the sum beam and the second signal strength of the difference beam of each of the beam groups on the azimuth ray includes: if the sum beam of the beam group on the azimuth ray includes a plurality of signal strength values, comparing the plurality of signal strength values numerically, and determining a signal strength value on a main lobe of the sum beam as the first signal strength.

Lobes of the antenna include the main lobe, a minor lobe, a side lobe, and back lobe. The main lobe is the largest radiation beam located on the antenna pattern. An origin of the main lobe is related to an antenna directivity, which refers to a relationship between a relative value of an antenna radiation field and a spatial direction under a condition of the same distance in a far zone.

Therefore, after setting the azimuth angle and the azimuth ray, there may be multiple intersection points between the azimuth ray and the sum beam. The multiple intersection points include an intersection point with the main lobe and an intersection point with the back lobe. By comparing values of the signal strengths of the intersection points, the intersection point corresponding to the maximum signal strength is determined as the first signal strength.

Alternatively, after determining the signal strength value on the main lobe of the sum beam as the first signal strength, it also includes: based on a coordinate axis and the coordinate origin of the beam coordinate system, dividing the beam coordinate system into four coordinate areas in 360° direction; determining a signal strength value of the difference beam of an antenna mode in a same position area as the first signal strength as the second signal strength.

The first signal strength of the sum beam corresponds to the signal strength on the main lobe of the sum beam, and the relationship between the signal source and the sum beam corresponds to the relationship between the main lobe of the sum beam and the signal source. Therefore, when there are multiple signal strengths of the difference beam, the signal strength in the same coordinate area as the first signal strength is selected as the second signal strength.
104, analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

Under the same signal source, when the azimuth of the signal source is fixed, when different azimuth angles are set, the intersection points of the azimuth ray, the sum beam, and the difference beam corresponding to different azimuth angles will be different, resulting in different values of signal strength differences. In other words, different gains are generated, and the difference in gain size changes with the azimuth angle, thus presenting a certain variation law. In addition, by switching the working mode of the antenna, that is, controlling the phase and excitation amplitude of each antenna, it is possible to use the sum and difference beams to receive signals from the same signal source respectively. The difference in signal strength difference will present a certain variation law with the azimuth angle, and the possible location of the signal source can be determined by the variation law.

Furthermore, the direction verification is performed on the signal source by using multiple beam groups to determine a final position of the signal source. The direction verification method is illustrated with examples shown in FIG. 4 to FIG. 8.

As shown in FIG. 4, the signal strength of the sum beam is large, while as shown in FIG. 5, the signal strength of the sum beam is small, so it can be ruled out that the signal source is in the direction of the rear 180°.

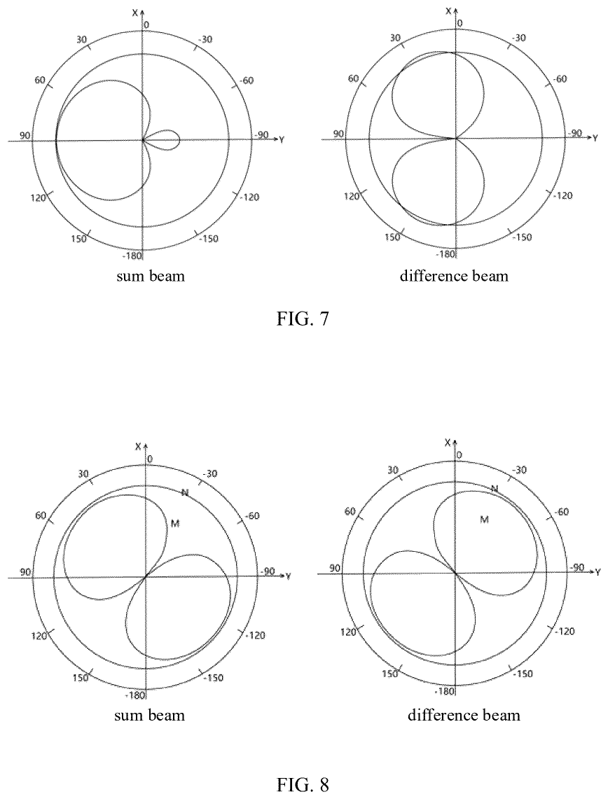

Furthermore, in a state of FIG. 6, the signal strength of the sum beam is large, while in the state of FIG. 7, the signal strength of the sum beam is small, which indicates that the signal source is within a range of 0 to −90°.

Furthermore, in a state of FIG. 8, the signal strength of the difference beam on a left side is small, while the signal strength of the difference beam on a right side is large, and it is determined that the signal source is within a range of the azimuth angle of −30° to −60°.

The method for monitoring the azimuth of the signal source of the embodiment of the present application is applied to the smart terminal, including: controlling the phases and the excitation amplitudes of the four antennas in the smart terminal respectively through the radio frequency switch and the phase-shift power division network to generate the plurality of beam groups, where each of the beam groups includes the sum beam and the difference beam, and the four antennas include the first antenna, the second antenna, the third antenna, and the fourth antenna arranged in four directions; mapping the beam patterns corresponding to the sum beam and the difference beam in each of the beam groups in the preset beam coordinate system; setting the at least one azimuth angle, setting the corresponding azimuth ray from the coordinate origin of the beam coordinate system based on the azimuth angle, and acquiring the signal strength difference of the sum beam and the difference beam in each of the beam groups on the azimuth ray; analyzing the variation law between the signal strength difference and the azimuth angle based on the signal strength difference and the azimuth angle of each of the beam groups, performing the direction verification on the direction of the signal source based on the comparison of signal strengths of the sum beam and the difference beam of the plurality of beam groups, and determining the azimuth of the signal source based on the variation law and the result of the direction verification. Through the above method, the smart device can automatically locate the azimuth of the signal source according to the variation law of the signal strength difference of the antenna with the azimuth angle and the verification result of the azimuth of the signal source through the multiple beam groups, thereby adjusting the working mode of the antenna for optimal signal reception relative to the signal source to ensure the network transmission performance of the smart device.

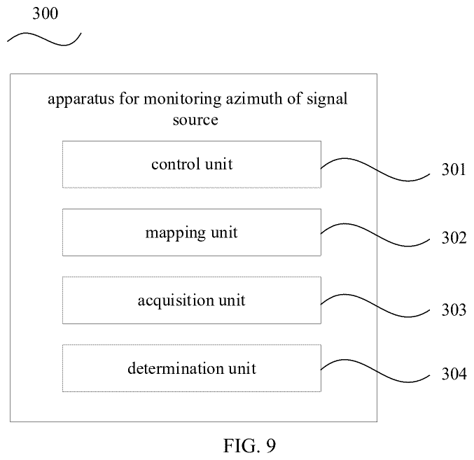

Please refer to FIG. 9, which is a schematic diagram of a structure of an apparatus for monitoring an azimuth of a signal source provided in an embodiment of the present application. An apparatus 300 for monitoring an azimuth of a signal source includes the following units:

A control unit 301 is configured to control phases and excitation amplitudes of four antennas in the smart terminal respectively through a radio frequency switch and a phase-shift power division network to generate a plurality of beam groups, where each of the beam groups includes a sum beam and a difference beam, and the four antennas include a first antenna, a second antenna, a third antenna, and a fourth antenna arranged in four directions.

A mapping unit 302 is configured to map beam patterns corresponding to the sum beam and the difference beam in each of the beam groups in a preset beam coordinate system.

An acquisition unit 303 is configured to set at least one azimuth angle, set a corresponding azimuth ray from a coordinate origin of the beam coordinate system based on the azimuth angle, and acquire a signal strength difference of the sum beam and the difference beam in each of the beam groups on the azimuth ray.

A determination unit 304 is configured to analyze a variation law between the signal strength difference and the azimuth angle based on the signal strength difference and the azimuth angle of each of the beam groups, perform a direction verification on a direction of the signal source based on a comparison of signal strengths of the sum beam and the difference beam of the plurality of beam groups, and determine the azimuth of the signal source based on the variation law and a result of the direction verification.

Alternatively, the acquisition unit 303 may also include the following subunits:

An acquisition subunit is configured to acquire a first signal strength of the sum beam and a second signal strength of the difference beam of each of the beam groups on the azimuth ray.

A calculation subunit is configured to solve a difference between the first signal strength and the second signal strength as the signal strength difference of the beam group.

Alternatively, the apparatus 200 for monitoring the azimuth of the signal source of the embodiment of the present application may further include other functional units and sub-units, which are not described in detail here.

The apparatus 200 for monitoring the azimuth of the signal source of the embodiment of the present application is applied to the smart terminal, and includes the control unit 301 configured to control the phases and the excitation amplitudes of the four antennas in the smart terminal respectively through the radio frequency switch and the phase-shift power division network to generate the plurality of beam groups, where each of the beam groups includes the sum beam and the difference beam, and the four antennas include the first antenna, the second antenna, the third antenna, and the fourth antenna arranged in four directions; the mapping unit 302 configured to map the beam patterns corresponding to the sum beam and the difference beam in each of the beam groups in the preset beam coordinate system; the acquisition unit 303 configured to set the at least one azimuth angle, set the corresponding azimuth ray from the coordinate origin of the beam coordinate system based on the azimuth angle, and acquire the signal strength difference of the sum beam and the difference beam in each of the beam groups on the azimuth ray; the determination unit 304 configured to analyze the variation law between the signal strength difference and the azimuth angle based on the signal strength difference and the azimuth angle of each of the beam groups, perform the direction verification on the direction of the signal source based on the comparison of signal strengths of the sum beam and the difference beam of the plurality of beam groups, and determine the azimuth of the signal source based on the variation law and the result of the direction verification. Through the above apparatus, the smart device can automatically locate the azimuth of the signal source according to the variation law of the signal strength difference of the antenna with the azimuth angle and the verification result of the azimuth of the signal source through the multiple beam groups, thereby adjusting the working mode of the antenna for optimal signal reception relative to the signal source to ensure the network transmission performance of the smart device.

The smart device of the present application includes a processor with one or more processing cores, a memory with one or more computer-readable storage media, and a computer program stored in the memory and executable on the processor 1. The processor is electrically connected to the memory. Those skilled in the art will appreciate that the structure of the smart device shown in the figure does not constitute a limitation on the smart device, and may include more or fewer components than shown in the figure, or combine certain components, or arrange the components differently.

The processor is a control center of the smart device. It uses various interfaces and lines to connect the various parts of the entire smart device. It executes various functions of the smart device and processes data by running or loading software programs and/or modules stored in the memory and calling data stored in the memory, thereby monitoring the smart device as a whole.

In the embodiment of the present application, the processor in the smart device will load instructions corresponding to the processes of one or more application programs into the memory according to the following steps, and the processor will run the application programs stored in the memory to implement various functions:
controlling phases and excitation amplitudes of four antennas in the smart terminal respectively through a radio frequency switch and a phase-shift power division network to generate a plurality of beam groups, where each of the beam groups includes a sum beam and a difference beam, and the four antennas include a first antenna, a second antenna, a third antenna, and a fourth antenna arranged in four directions.
mapping beam patterns corresponding to the sum beam and the difference beam in each of the beam groups in a preset beam coordinate system.
setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray.
analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

The specific implementation of each of the above operations can be referred to the previous embodiments, which will not be described in detail here.

Those skilled in the art can understand that the structure of the smart device described above does not constitute a limitation on the smart device, and can include more or fewer components than shown in the figure, or combine certain components, or arrange components differently.

It is understandable that the smart device can also include other functional modules and electronic structures, which will not be described in detail here.

In the above embodiments, the description of each embodiment has its own emphasis. For parts that are not described in detail in a certain embodiment, reference can be made to the relevant descriptions of other embodiments.

As can be seen from the above, the smart device provided in this embodiment can be used to process the following processes: controlling the phases and the excitation amplitudes of the four antennas in the smart terminal respectively through the radio frequency switch and the phase-shift power division network to generate the plurality of beam groups, where each of the beam groups includes the sum beam and the difference beam, and the four antennas include the first antenna, the second antenna, the third antenna, and the fourth antenna arranged in four directions; mapping the beam patterns corresponding to the sum beam and the difference beam in each of the beam groups in the preset beam coordinate system; setting the at least one azimuth angle, setting the corresponding azimuth ray from the coordinate origin of the beam coordinate system based on the azimuth angle, and acquiring the signal strength difference of the sum beam and the difference beam in each of the beam groups on the azimuth ray; analyzing the variation law between the signal strength difference and the azimuth angle based on the signal strength difference and the azimuth angle of each of the beam groups, performing the direction verification on the direction of the signal source based on the comparison of signal strengths of the sum beam and the difference beam of the plurality of beam groups, and determining the azimuth of the signal source based on the variation law and the result of the direction verification.

A person of ordinary skill in the art will appreciate that all or part of the steps in the various methods of the above embodiments may be completed by instructions, or by controlling related hardware through instructions. The instructions may be stored in a computer-readable storage medium and loaded and executed by a processor.

To this end, an embodiment of the present application provides a computer-readable storage medium, in which a plurality of computer programs are stored, and the computer program can be loaded by a processor to execute the steps in any method for monitoring an azimuth of a signal source provided in the embodiment of the present application. For example, the computer program can execute the following steps:
controlling phases and excitation amplitudes of four antennas in the smart terminal respectively through a radio frequency switch and a phase-shift power division network to generate a plurality of beam groups, where each of the beam groups includes a sum beam and a difference beam, and the four antennas include a first antenna, a second antenna, a third antenna, and a fourth antenna arranged in four directions.
mapping beam patterns corresponding to the sum beam and the difference beam in each of the beam groups in a preset beam coordinate system.
setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray.
analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

The specific implementation of each of the above operations can be found in the previous embodiments, which will not be repeated here.

The storage medium may include: a read-only memory (ROM), a random access memory, a disk or a CD, etc.

Since the computer program stored in the storage medium can execute the steps in any method for monitoring the azimuth of the signal source provided in the embodiments of the present application, the beneficial effects that can be achieved by any method for monitoring the azimuth of the signal source provided in the embodiments of the present application can be achieved. Please refer to the previous embodiments for details and will not be repeated here.

The above is a detailed introduction to the method and the apparatus for monitoring the azimuth of the signal source, the storage medium, and the smart device provided in the embodiments of the present application. Specific examples are used herein to illustrate the principles and implementation methods of the present application. The description of the above embodiments is only used to help understand the method and core idea of the present application. At the same time, for those skilled in the art, according to the idea of the present application, there will be changes in the specific implementation method and scope of application. In summary, the content of this specification should not be understood as a limitation on the present application.

1. A method for monitoring an azimuth of a signal source, applied to a smart device, wherein the method comprises:
controlling phases and excitation amplitudes of four antennas in the smart terminal respectively through a radio frequency switch and a phase-shift power division network to generate a plurality of beam groups, wherein each of the beam groups comprises a sum beam and a difference beam, and the four antennas comprise a first antenna, a second antenna, a third antenna, and a fourth antenna arranged in four directions;
mapping beam patterns corresponding to the sum beam and the difference beam in each of the beam groups in a preset beam coordinate system;
setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray;
analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

2. The method for monitoring the azimuth of the signal source according to claim 1, wherein the setting the at least one azimuth angle, setting the corresponding azimuth ray from the coordinate origin of the beam coordinate system based on the azimuth angle, and acquiring the signal strength difference of the sum beam and the difference beam in each of the beam groups on the azimuth ray, comprises:
acquiring a first signal strength of the sum beam and a second signal strength of the difference beam of each of the beam groups on the azimuth ray;
solving a difference between the first signal strength and the second signal strength as the signal strength difference of the beam group.

3. The method for monitoring the azimuth of the signal source according to claim 2, wherein the acquiring the first signal strength of the sum beam and the second signal strength of the difference beam of each of the beam groups on the azimuth ray comprises:
if the sum beam of the beam group on the azimuth ray comprises a plurality of signal strength values, comparing the plurality of signal strength values numerically, and determining a signal strength value on a main lobe of the sum beam as the first signal strength.

4. The method for monitoring the azimuth of the signal source according to claim 3, wherein after determining the signal strength value on the main lobe of the sum beam as the first signal strength, the method further comprises:
based on a coordinate axis and the coordinate origin of the beam coordinate system, dividing the beam coordinate system into four coordinate areas in 360° direction;
determining a signal strength value of the difference beam of an antenna mode in a same position area as the first signal strength as the second signal strength.

5. The method for monitoring the azimuth of the signal source according to claim 1, wherein the controlling the phases and the excitation amplitudes of the four antennas in the smart terminal respectively through the radio frequency switch and the phase-shift power division network to generate the plurality of beam groups, each of the beam groups comprising the sum beam and the difference beam, and the four antennas comprising the first antenna, the second antenna, the third antenna, and the fourth antenna arranged in four directions comprises:
controlling the first antenna and the second antenna to have a same phase and a same amplitude, and controlling the third antenna and the fourth antenna to have a same phase and a same amplitude, and simultaneously controlling the first antenna and the second antenna to be in a first phase, and obtaining a sum beam radiated in a preset direction.

6. The method for monitoring the azimuth of the signal source according to claim 1, wherein the controlling the phases and the excitation amplitudes of the four antennas in the smart terminal respectively through the radio frequency switch and the phase-shift power division network to generate the plurality of beam groups, each of the beam groups comprising the sum beam and the difference beam, and the four antennas comprising the first antenna, the second antenna, the third antenna, and the fourth antenna arranged in four directions comprises:
controlling the excitation amplitudes of the first antenna and the fourth antenna to be the same, and controlling the second antenna and the third antenna not to be excited, and obtaining a difference beam radiated in a preset direction by adjusting a phase difference between the first antenna and the fourth antenna.

7. The method for monitoring the azimuth of the signal source according to claim 1, wherein the four antennas are all configured as vertically polarized antennas.

8. An apparatus for monitoring an azimuth of a signal source, applied to a smart device, wherein the apparatus comprises:
a control unit configured to control phases and excitation amplitudes of four antennas in the smart terminal respectively through a radio frequency switch and a phase-shift power division network to generate a plurality of beam groups, wherein each of the beam groups comprises a sum beam and a difference beam, and the four antennas comprise a first antenna, a second antenna, a third antenna, and a fourth antenna arranged in four directions;
a mapping unit configured to map beam patterns corresponding to the sum beam and the difference beam in each of the beam groups in a preset beam coordinate system;
an acquisition unit configured to set at least one azimuth angle, set a corresponding azimuth ray from a coordinate origin of the beam coordinate system based on the azimuth angle, and acquire a signal strength difference of the sum beam and the difference beam in each of the beam groups on the azimuth ray;
a determination unit configured to analyze a variation law between the signal strength difference and the azimuth angle based on the signal strength difference and the azimuth angle of each of the beam groups, perform a direction verification on a direction of the signal source based on a comparison of signal strengths of the sum beam and the difference beam of the plurality of beam groups, and determine the azimuth of the signal source based on the variation law and a result of the direction verification.

9-10. (canceled)

11. A method for monitoring an azimuth of a signal source, applied to a smart device, wherein the method comprises:
controlling phases and excitation amplitudes of four antennas in the smart terminal respectively through a radio frequency switch and a phase-shift power division network to generate a plurality of beam groups, wherein each of the beam groups comprises a sum beam and a difference beam, the four antennas are all configured as vertically polarized antennas, and the four antennas comprise a first antenna, a second antenna, a third antenna, and a fourth antenna arranged in four directions;
mapping beam patterns corresponding to the sum beam and the difference beam in each of the beam groups in a preset beam coordinate system;
setting at least one azimuth angle, setting a corresponding azimuth ray from a coordinate origin of the beam coordinate system based on the azimuth angle, and acquiring a signal strength difference of the sum beam and the difference beam in each of the beam groups on the azimuth ray;
analyzing a variation law between the signal strength difference and the azimuth angle based on the signal strength difference and the azimuth angle of each of the beam groups, performing a direction verification on a direction of the signal source based on a comparison of signal strengths of the sum beam and the difference beam of the plurality of beam groups, and determining the azimuth of the signal source based on the variation law and a result of the direction verification.

12. The method for monitoring the azimuth of the signal source according to claim 11, wherein the phases and the excitation amplitudes of the four antennas are controlled so that working modes of the four antennas exhibit are different, and in each of the working modes, different beam groups are generated relative to the signal source, and each of the beam groups comprises the sum beam and the difference beam.

13. The method for monitoring the azimuth of the signal source according to claim 11, wherein the setting the at least one azimuth angle, setting the corresponding azimuth ray from the coordinate origin of the beam coordinate system based on the azimuth angle, and acquiring the signal strength difference of the sum beam and the difference beam in each of the beam groups on the azimuth ray, comprises:
acquiring a first intersection point of the azimuth ray with the sum beam and a second intersection point of the azimuth ray with the difference beam, serving a signal strength at the first intersection point as a first signal strength of the sum beam, and serving a signal strength at the second intersection point as a second signal strength of the difference beam;
solving a difference between the first signal strength and the second signal strength as the signal strength difference of the beam group.

14. The method for monitoring the azimuth of the signal source according to claim 13, wherein the acquiring the first intersection point of the azimuth ray with the sum beam and the second intersection point of the azimuth ray with the difference beam, serving the signal strength at the first intersection point as the first signal strength of the sum beam, and serving the signal strength at the second intersection point as the second signal strength of the difference beam, comprises:
if there are a plurality of intersection points between the azimuth ray and the sum beam, comparing values of signal strengths of the intersection points, and serving a determined signal strength with a maximum value of a corresponding intersection point as the first signal strength.

15. The method for monitoring the azimuth of the signal source according to claim 14, wherein the first signal strength is a main lobe signal strength value of the sum beam.

16. The method for monitoring the azimuth of the signal source according to claim 14, wherein after determining the first signal strength, the method further comprises:
when there are a plurality of signal strengths of the difference beam, selecting a signal strength located in a same coordinate area as the first signal strength as the second signal strength.

17. The method for monitoring the azimuth of the signal source according to claim 16, wherein the selecting the signal strength located in the same coordinate area as the first signal strength as the second signal strength when there are the plurality of signal strengths of the difference beam, comprises:
based on a coordinate axis and the coordinate origin of the beam coordinate system, dividing the beam coordinate system into four coordinate areas in 360° direction;
selecting the signal strength located in the same coordinate area as the first signal strength as the second signal strength.

18-20. (canceled)

21. The apparatus according to claim 8, wherein the acquisition unit is further configured to acquire a first signal strength of the sum beam and a second signal strength of the difference beam of each of the beam groups on the azimuth ray, and solve a difference between the first signal strength and the second signal strength as the signal strength difference of the beam group.

22. The apparatus according to claim 21, wherein if the sum beam of the beam group on the azimuth ray comprises a plurality of signal strength values, the determination unit is further configured to compare the plurality of signal strength values numerically, and determine a signal strength value on a main lobe of the sum beam as the first signal strength.

23. The apparatus according to claim 22, wherein the determination unit is further configured to divide the beam coordinate system into four coordinate areas in 360° direction based on a coordinate axis and the coordinate origin of the beam coordinate system, and determine a signal strength value of the difference beam of an antenna mode in a same position area as the first signal strength as the second signal strength.

24. The apparatus according to claim 8, wherein the determination unit is further configured to control the first antenna and the second antenna to have a same phase and a same amplitude, and control the third antenna and the fourth antenna to have a same phase and a same amplitude, and simultaneously control the first antenna and the second antenna to be in a first phase, and obtaining a sum beam radiated in a preset direction.

25. The apparatus according to claim 8, wherein the determination unit is further configured to control the excitation amplitudes of the first antenna and the fourth antenna to be the same, and control the second antenna and the third antenna not to be excited, and obtain a difference beam radiated in a preset direction by adjusting a phase difference between the first antenna and the fourth antenna.
